(19) United States
(12) Patent Application Publication
(10) Pub. No.: US 2007/0097614 A1
(43) Pub. Date: May 3, 2007

(54) Battery apparatus for different kinds of notebook computers

(76) Inventors: Mao-Chen Hsiao, Shulin City (TW); Terry Chang, Tainan Hsien (TW)

Correspondence Address: RABIN & BERDO, P.C., Suite 500, 1101 14 Street, N.W., Washington, DC, 20005, US

(21) Appl. No.: 11/293,303

(22) Filed: Dec. 5, 2005

(30) Foreign Application Priority Data
Oct. 28, 2005 (TW) 94218694

(51) Int. Cl. G06F 1/16

(52) U.S. Cl. 361/683

(57) ABSTRACT

A common battery design for different kinds of notebook computers is provided. The common battery design includes a battery body and an L-shaped cover. The battery body has three pairs of parallel surfaces, and each of a first pair of parallel surfaces includes a set of grooves. The L-shaped cover has two sets of hooks respectively clamping two sets of grooves on the first pair of parallel surfaces. The L-shaped cover covers up one of a first pair of parallel surfaces and its adjacent surface so as to form part of a notebook computer's housing. The L-shaped cover can have the same material or color as the notebook computer with which the L-shaped cover matches. The common battery design is then suitable for different kinds of notebook computers.

### RELATED APPLICATIONS

The present application is based on, and claims priority from, Taiwan Application Serial Number 94218694, filed Oct. 28, 2005, the disclosure of which is hereby incorporated by reference herein in its entirety.

### BACKGROUND

1. Field of Invention

The present invention relates to a battery apparatus. More particularly, the present invention relates to a battery apparatus suitable for different kinds of notebook computer.

2. Description of Related Art

A battery is a very important component of any notebook computer. When the notebook computer is located in a place where no external power is available, the battery becomes the only way to supply power.

Conventionally, a battery apparatus is uniquely designed to match a certain notebook computer, in color or material. In order to satisfy such requirements, manufacturing costs for the battery apparatus are constrained and hard to reduce. Thus, battery apparatus venders are interested in reducing costs of new battery design as well as costs of battery materials management.

### SUMMARY

It is therefore an objective of the present invention to provide a battery apparatus of a common battery design for different kinds of notebook computers.

In accordance with the foregoing and other objectives of the present invention, a common battery design for different kinds of notebook computers is provided. The common battery design includes a battery body and an L-shaped cover. The battery body has three pairs of parallel surfaces, and each of a first pair of parallel surfaces includes a set of grooves. The L-shaped cover has two sets of hooks respectively clamping two sets of grooves on the first pair of parallel surfaces. The L-shaped cover covers up one of a first pair of parallel surfaces and its adjacent surface so as to form part of a notebook computer's housing. The L-shaped cover can have the same material or color as the notebook computer that the battery body belongs to; the common battery design is then suitable for different kinds of notebook computers.

Thus, the battery apparatus, because of a common battery design, can be suitable for different kinds of notebook computers so as to reduce costs of new battery design and costs of battery materials management. Moreover, when a new type of notebook computer is designed, a potential shortcoming in battery design can be avoided based on an old common battery design.

It is to be understood that both the foregoing general description and the following detailed description are by examples and are intended to provide further explanation of the invention as claimed.

### BRIEF DESCRIPTION OF THE DRAWINGS

The accompanying drawings are included to provide a further understanding of the invention and are incorporated in and constitute a part of this specification. The drawings illustrate embodiments of the invention and, together with the description, serve to explain the principles of the invention. In the drawings,

FIG. 1 illustrates a battery apparatus and a notebook computer to which the battery apparatus belongs according to one preferred embodiment of this invention;

FIG. 2 illustrates a battery apparatus according to one preferred embodiment of this invention;

FIGS. 3A and 3B respectively illustrate grooves located on a pair of parallel surfaces according to one preferred embodiment of this invention;

FIG. 4 illustrates a battery apparatus and its cover according to one preferred embodiment of this invention; and

FIG. 5 illustrates a battery apparatus to which a tape is attached according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to reduce costs of new battery design and costs of battery materials management, preferred embodiments of the present invention provide a common battery design for different kinds of notebook computers. The common battery design includes a battery body and a cover attached to it. The cover has the same material or color as the notebook computer to which the battery body belongs. Therefore, the combination of a battery body and a cover with the same material or color as the notebook computer can form a common battery design for different kinds of notebook computers.

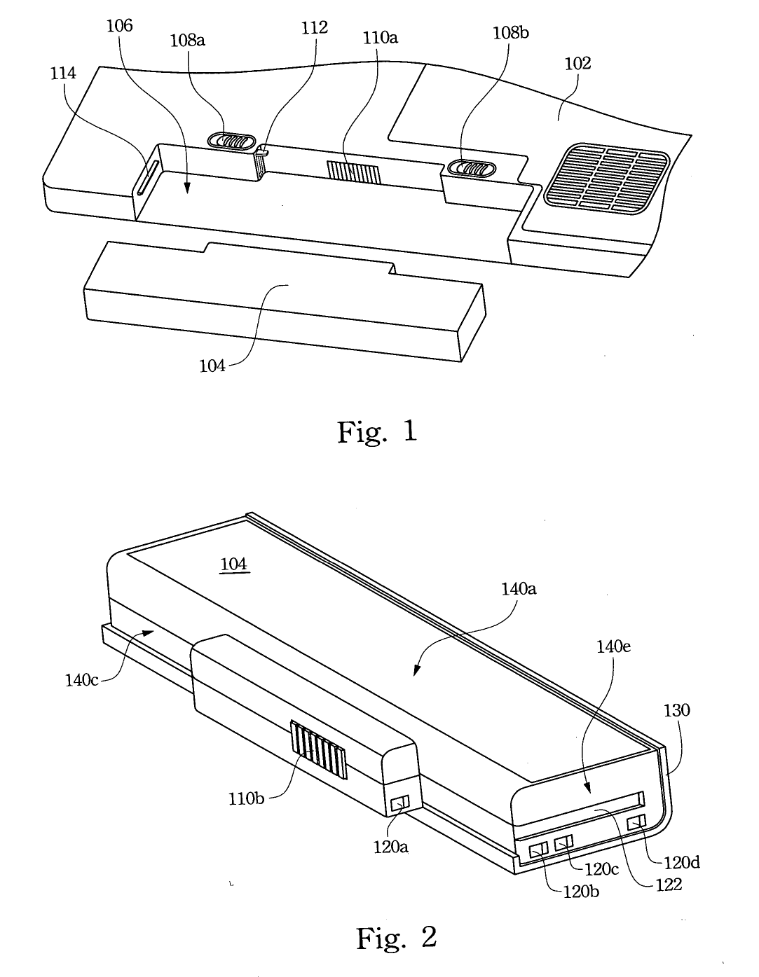

FIG. 1 illustrates a battery apparatus and a notebook computer to which the battery apparatus belongs according to one preferred embodiment of this invention. A cutout 106 on a notebook computer 102 can accommodate a battery body 104. When the battery body 104 is inserted into the cutout 106, a rail 114 (another rail is on the right side of the cutout but not illustrated in drawings) is used to fit and secure the battery body 104. After the battery body 104 is inserted into the cutout 106, a lock hook 112 (another hook is on the right side of the cutout but not illustrated in drawings) is used to secure the battery body 104 in the notebook computer 102. Lock switches 108a and 108b are used to control the lock hooks in order to lock or unlock the battery body 104 within the cutout 106. When locked, the lock switch 108a and the lock hook 112 are disposed as illustrated in FIG. 1. When unlocked, the lock hook 112 is withdrawn when the lock switch 108a is pushed to the left position. A connector 110a in the cutout 106 is used to couple the battery body 104 to the notebook computer so as to provide power thereto.

FIG. 2 illustrates a battery apparatus according to one preferred embodiment of this invention. The battery apparatus of FIG. 2 is shown flipped over in relation to the battery apparatus shown in FIG. 1. The battery body 104 can be considered as a parallelepiped, which has three pairs of parallel surfaces, except for a battery connector 110b. A surface 140a and its opposite surface are a pair of parallel surfaces. Due to limitations in viewpoint, FIG. 2 only illustrates one of each pair of parallel surfaces, surfaces 140a, 140c and 140e. An elongated groove 122 and recesses 120a, 120b, 120c and 140e are located on the surface 140e and its opposite surface (not illustrated in drawings). Referring to FIGS. 1 and 2, when the battery body 104 is inserted into the cutout 106, the rail 114 fits into elongated groove 122 and the lock hook 112, clamping the recess 120a so as to secure the battery body 104 to the cutout 106. Recesses 120a, 120b, 120c and 120d are preset on the surface 140e and its opposite surface to meet a lock hook 112 of different locations. Therefore, when a cutout 106 of a notebook computer is designed, the location of the lock hook is flexibly chosen.

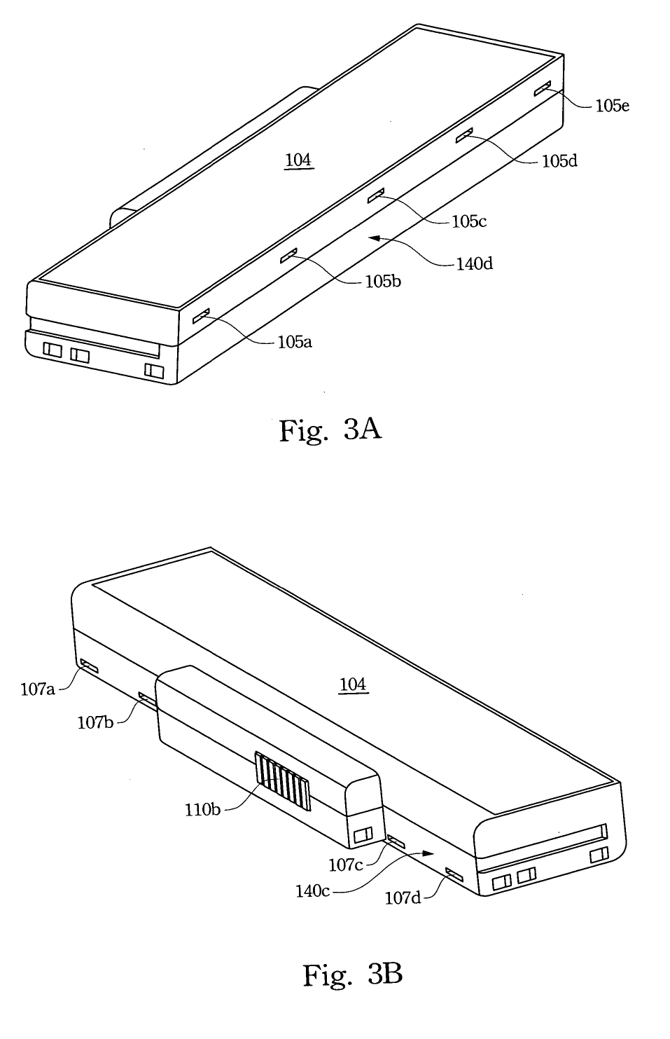

FIGS. 3A and 3B respectively illustrate grooves located on a pair of parallel surfaces according to one preferred embodiment of this invention. The surface 140d of FIG. 3A and the surface 140c of FIG. 3B are a pair of parallel surfaces. A set of grooves 105a, 105b, 105c, 105d and 105e are located on the surface 140d, and another set of grooves 107a, 107b, 107c and 107d as well as a connector 110b are located on the surface 140c. All grooves mentioned above are to secure an L-shaped cover. A set of grooves should include at least two grooves in order to secure an L-shaped cover firmly. The quantity of groove depends upon the area of the surfaces 140. Referring to FIGS. 1 and 3B, the battery connector 110b is employed to contact the connector 110a to supply power to the notebook computer 102.

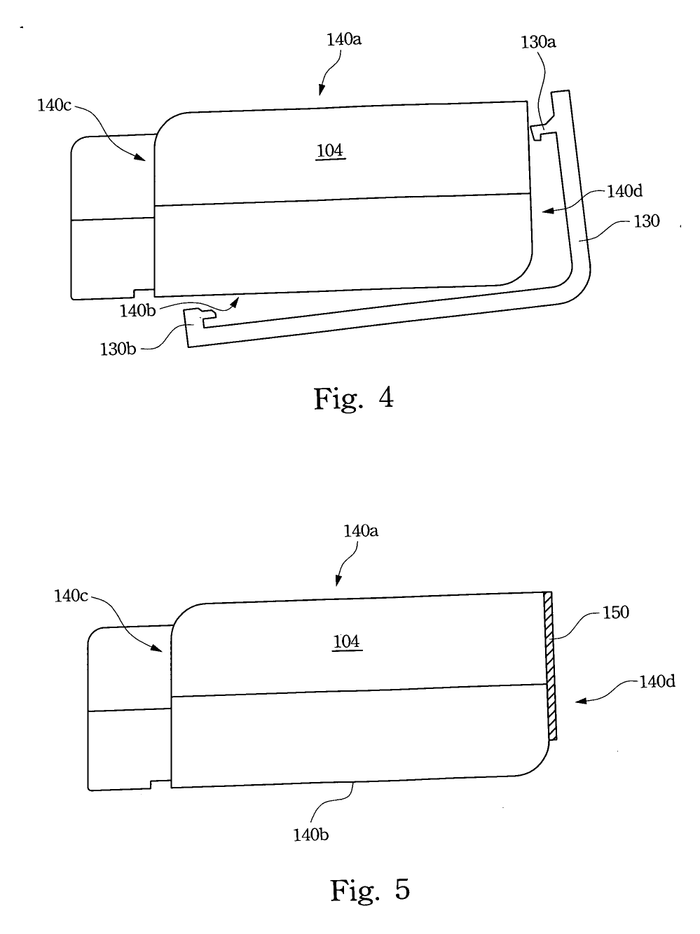

FIG. 4 illustrates a battery apparatus and its cover according to one preferred embodiment of this invention. An L-shaped cover 130 is attached to the battery body 104 to match different kinds of computer in material or color. The L-shaped cover 130 can have the same color or material as the housing of the notebook computer 102 in order to save material cost. The L-shaped cover 130 has hooks 130a and 130b so as to clamp the battery body 104. The hooks 130a can clamp grooves (such as grooves 105a, 105b, 105c, 105d and 105e illustrated in FIG. 3A) on the surface 140d, and the hooks 130a can clamp grooves (such as grooves 107a, 107b, 107c and 107d) on the surface 140c. The L-shaped cover 130 covers up the surface 140d and its adjacent surface 140b, and its hooks 130b extend to surface 140c. The quantity of hooks 130a and 130b should match with the quantity of grooves.

FIG. 5 illustrates a battery apparatus to which a tape is attached according to one preferred embodiment of this invention. When the battery body 104 matches with the notebook computer 102 in color, the battery body 104 itself can be inserted into the cutout without a cover. Due to appearance considerations, a tape 150 (the tape can be a bulk tape covering all grooves or several tapes, covering separate grooves) can be attached to the surface 140d (and 140c). Thus, the battery body itself can be assembled to a notebook computer with matched color.

According to preferred embodiments described above, the battery apparatus, because of a common battery design, can be suitable for different kinds of notebook computers so as to reduce costs of new battery design and costs of battery materials management. Moreover, when a new type of notebook computer is designed, a potential shortcoming in battery design can be avoided based on an old common battery design.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A battery apparatus for different kinds of notebook computers, comprising:
a battery body, having three pairs of parallel surfaces, each of a first said pair of parallel surfaces including a set of grooves; and
an L-shaped cover, having two sets of hooks respectively clamping two said sets of grooves, wherein said L-shaped cover covers up one of a first said pair of parallel surfaces and its adjacent surface so as to form part of a notebook computer's housing.

2. The battery apparatus of claim 1, wherein said L-shaped cover has the same material and color as the notebook computer's housing.

3. The battery apparatus of claim 1, wherein each of two said sets of grooves has at least two grooves.

4. The battery apparatus of claim 1, wherein said battery body further comprises a connector coupled to a notebook computer so as to supply power.

5. A battery apparatus for different kinds of notebook computers, said battery apparatus comprising:
a battery body, having three pairs of parallel surfaces, each of a first said pair of parallel surfaces including at least an elongated groove and a recess, each of a second said pair of parallel surfaces including a set of grooves, wherein said at least an elongated groove and a recess is used to assemble said battery body into a notebook computer; and
an L-shaped cover, having two sets of hooks respectively clamping two said sets of grooves, wherein said L-shaped cover covers up one of a second said pair of parallel surfaces and its adjacent surface so as to form part of the notebook computer's housing.

6. The battery apparatus of claim 5, wherein said L-shaped cover has the same material and color as the notebook computer's housing.

7. The battery apparatus of claim 5, wherein each of two said sets of grooves has at least two grooves.

8. The battery apparatus of claim 5, wherein said battery body further comprises a connector coupled to a notebook computer so as to supply power.

9. A battery apparatus comprising:
a battery body, having three pairs of parallel surfaces, each of a first said pair of parallel surfaces including at least an elongated groove and a recess, each of a second said pair of parallel surfaces including a set of grooves, wherein said at least an elongated groove and a recess is used to assemble said battery body into a notebook computer; and
a tape, being attached to each of a second said pair of parallel surfaces to cover up said set of grooves.

10. The battery apparatus of claim 9, wherein said battery body has the same color as the notebook computers housing.

11. The battery apparatus of claim 9, wherein said tape has the same color as the notebook computer's housing.

12. The battery apparatus of claim 9, wherein each of two said sets of grooves has at least two grooves.

13. The battery apparatus of claim 9, wherein said battery body further comprises a connector coupled to a notebook computer so as to supply power.
